(19) United States
(12) Patent Application Publication
(10) Pub. No.: US 2026/0274603 A1
(43) Pub. Date: Sep. 17, 2026

(54) SHEET POSTPROCESSING DEVICE AND IMAGE FORMING SYSTEM

(71) Applicant: KYOCERA Document Solutions Inc., Osaka (JP)

(72) Inventors: Yasunori UENO, Osaka (JP); Terumitsu NOSO, Osaka (JP)

(73) Assignee: KYOCERA Document Solutions Inc., Osaka (JP)

(21) Appl. No.: 19/554,117

(22) Filed: Mar. 2, 2026

(30) Foreign Application Priority Data
Mar. 12, 2025 (JP) 2025-039626
Feb. 4, 2026 (JP) 2026-016763

(51) Int. Cl. B65H 29/24; B41J 13/02

(52) U.S. Cl. CPC B65H 29/245; B41J 13/02

(57) ABSTRACT

The sheet postprocessing device includes a stacking tray, a conveyance unit, a discharge tray, and an air blower. The discharge tray is placed on a downstream side of the stacking tray in a sheet conveyance direction, permitting sheets to be discharged thereon. The air blower blows an air flow, toward the downstream side in the sheet conveyance direction, to between a lower surface of the sheet conveyed from the conveyance unit to the stacking tray and a sheet laying surface of the stacking tray or an upper surface of the sheet stacked on the stacking tray.

### INCORPORATION BY REFERENCE

This application is based on and claims the benefit of priority from Japanese Patent Application No. 2025-039626 filed on March 12, 2025 and Japanese Patent Applications No. 2026-016763 filed on February 4, 2026, the contents of which are hereby incorporated by reference.

### BACKGROUND

The present disclosure relates to a sheet postprocessing device for applying postprocessing to sheets on which images have been formed by an image forming apparatus, and also relates to an image forming system equipped with the sheet postprocessing device.

There have so far been known sheet postprocessing devices for executing postprocessing such as stapling process (stitching process) and folding process with sheets having been subjected to image formation thereon by a copier, printer, or other image forming apparatus.

### SUMMARY

A sheet postprocessing device according to one aspect of the present disclosure includes a stacking tray, a conveyance unit, a postprocessing unit, a discharge tray, and an air blower. On the stacking tray, a sheet to be subjected to postprocessing is stacked. The conveyance unit conveys the sheet from above the stacking tray onto the stacking tray. The postprocessing unit applies the postprocessing to the sheets stacked on the stacking tray. The discharge tray is placed on a downstream side of the stacking tray in a sheet conveyance direction, permitting sheets to be discharged thereon. The air blower blows an air flow, toward the downstream side in the sheet conveyance direction, to between a lower surface of the sheet conveyed from the conveyance unit to the stacking tray and a sheet laying surface of the stacking tray or an upper surface of the sheet stacked on the stacking tray.

### BRIEF DESCRIPTION OF THE DRAWINGS

FIG. 1 is a schematic cross-sectional front view of an image forming system according to one embodiment of the present disclosure;

FIG. 2 is a schematic cross-sectional front view of a sheet postprocessing device of FIG. 1;

FIG. 3 is a block diagram showing a schematic configuration of the sheet postprocessing device of FIG. 2;

FIG. 4 is a partly cross-sectional front view showing a vicinity of a stacking tray in the sheet postprocessing device of FIG. 2;

FIG. 5 is a partly cross-sectional front view showing a vicinity of the stacking tray in the sheet postprocessing device of FIG. 2, also being an explanatory view showing an air flow direction attributed to an air blower;

FIG. 6 is a plan view showing a vicinity of the air blower of FIG. 4;

FIG. 7 is a partly cross-sectional front view showing a vicinity of the stacking tray of FIG. 4, also being a view showing a state in which a succeeding sheet has been conveyed to above the stacking tray having a preceding sheet already stacked thereon;

FIG. 8 is a partly cross-sectional front view showing a vicinity of the stacking tray of FIG. 4, also being a view showing a state in which a succeeding sheet has been stacked on a preceding sheet precedently stacked on the stacking tray; and

FIG. 9 is a flowchart showing an example of sheet conveyance process bound for the stacking tray in the sheet postprocessing device of FIG. 2.

### DETAILED DESCRIPTION

Hereinbelow, an embodiment of the present disclosure will be described with reference to the accompanying drawings. It is noted that the disclosure is not limited to the following contents.

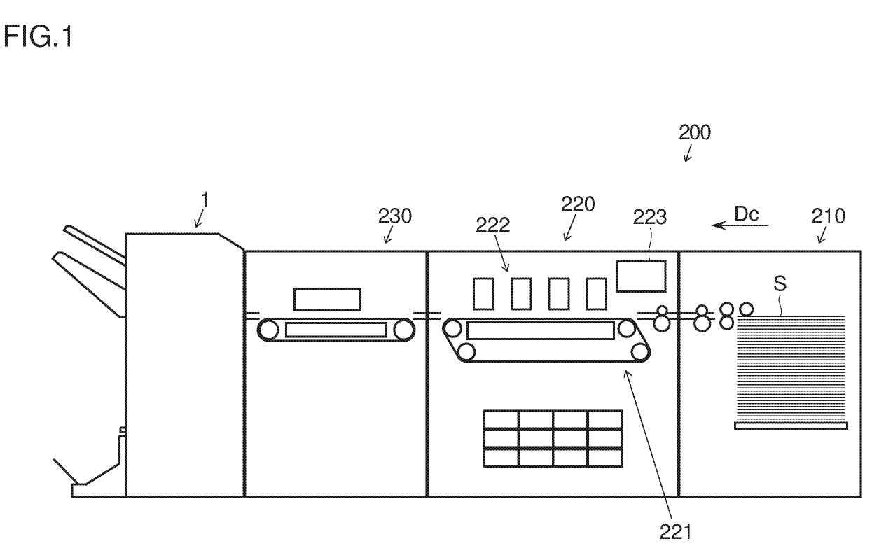

FIG. 1 is a schematic cross-sectional front view of an image forming system 200 according to one embodiment. Shown in FIG. 1 are component elements necessary for explanation of features of this embodiment, while other component elements are excluded from the description. Also omitted in FIG. 1 is depiction of the cross section of a sheet postprocessing device 1.

The image forming system 200 includes a sheet feeding device 210, an inkjet recording device 220, a sheet drying device 230, and a sheet postprocessing device 1. These devices are coupled to one another in the image forming system 200 in a sequence starting at the most upstream portion in a sheet conveyance direction Dc and ranging from the sheet feeding device 210 to the inkjet recording device 220 to the sheet drying device 230 to the sheet postprocessing device 1.

The sheet feeding device 210, containing a plurality of sheets (recording medium) S, separates and feeds sheets S, one by one, to the inkjet recording device 220.

The inkjet recording device 220 is, for example, an inkjet-recording type image forming apparatus. The inkjet recording device 220 records (forms) an image by an inkjet method on a sheet S conveyed from the sheet feeding device 210. The inkjet recording device 220, as shown in FIG. 1, is equipped, in its device body, with a conveyance unit 221, a recording unit 222, and a recording control unit 223.

The conveyance unit 221, receiving a sheet S from the sheet feeding device 210, allows the sheet S to pass through under the recording unit 222 to convey the sheet S toward the sheet drying device 230. The recording unit 222 is placed above the conveyance unit 221 in opposition to the conveyance unit 221. The recording unit 222 ejects ink of plural colors (e.g., four colors) in succession toward a sheet S being conveyed by the conveyance unit 221 to record a full-color or monochrome image on the sheet S. Based on programs and data for control use, the recording control unit 223 controls operations of individual component elements provided in the inkjet recording device 220 to fulfill processing relevant to functions of the inkjet recording device 220.

The sheet drying device 230 applies heat, thereby dries ink, to the sheet S on which an ink image has been recorded by the inkjet recording device 220. Then, the sheet drying device 230 conveys, to the sheet postprocessing device 1, the sheet S with which image recording (printing) with the ink dried has been completed.

The sheet postprocessing device 1 subjects the sheet S, with which image recording (printing) has been completed with the ink dried, to specified postprocessing, then discharging the sheet S onto a tray or the like that is extractable from external.

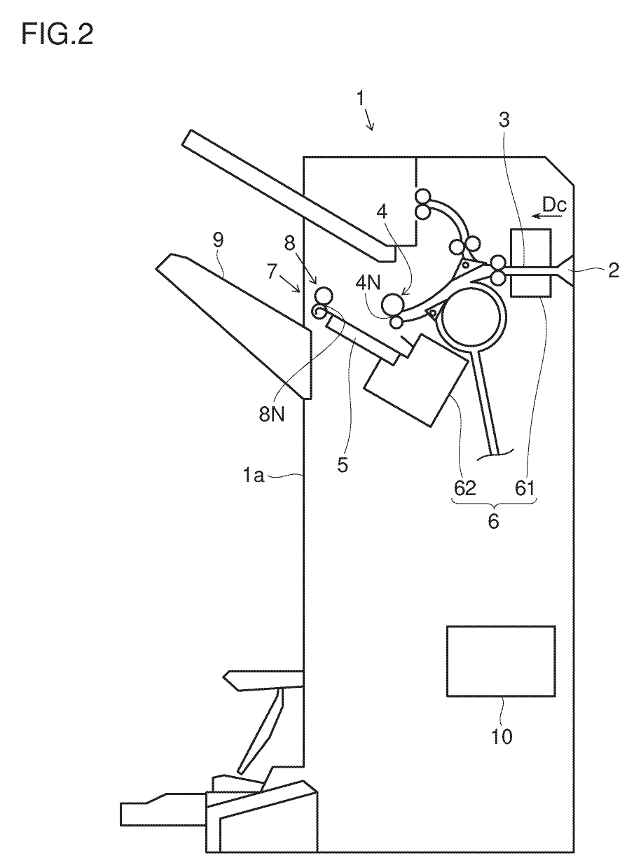

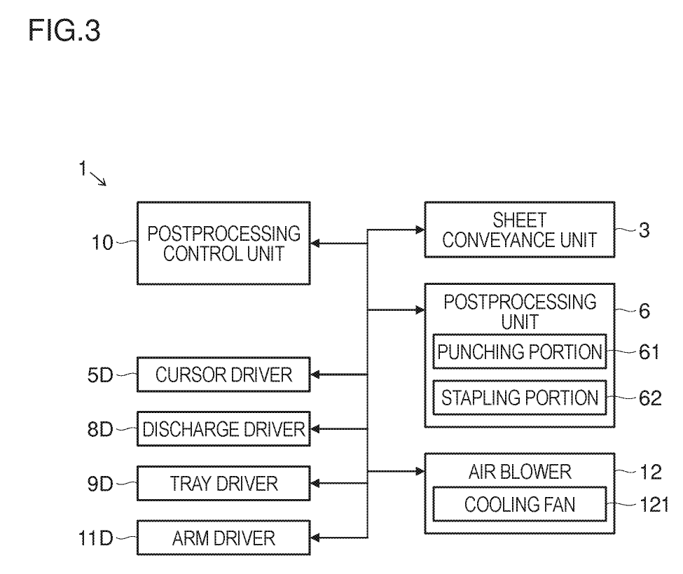

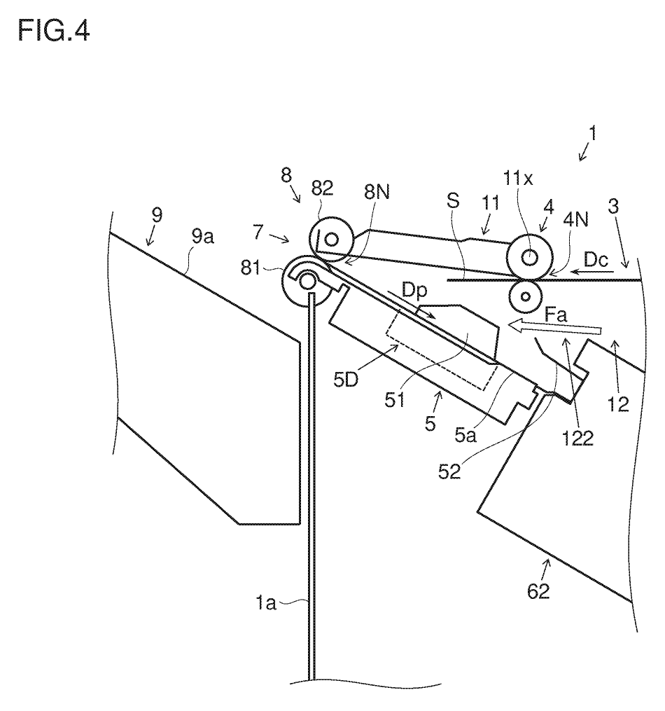

FIG. 2 is a schematic cross-sectional front view of the sheet postprocessing device 1 of FIG. 1. FIG. 3 is a block diagram showing a schematic configuration of the sheet postprocessing device 1 of FIG. 2. FIG. 4 is a partly cross-sectional front view showing a vicinity of a stacking tray 5 in the sheet postprocessing device 1 of FIG. 2. In addition, in the following description related to the sheet postprocessing device 1, a direction directed from right toward left side in FIGS. 2 and 4 is referred to as 'sheet conveyance direction' and denoted as an arrow Dc in FIG. 4 and following figures. As concerns the sheet conveyance direction Dc, the right side in contrast to the left side in FIGS. 2 and 4 is an 'upstream side' of the sheet conveyance direction Dc, and the left side in contrast to the right side in FIGS. 1 and 3 is a 'downstream side' of the sheet conveyance direction Dc. Also, a 'sheet widthwise direction' perpendicular to the sheet conveyance direction Dc refers to a direction vertical to each drawing sheet of FIGS. 2 and 4 and moreover similarly vertical to each drawing sheet of FIG. 4 and following figures.

The sheet postprocessing device 1, as shown in FIGS. 2, 3 and 4, includes a sheet carry-in port 2, a sheet conveyance unit (conveyance unit) 3, an intermediate roller pair 4, a stacking tray 5, a postprocessing unit 6, a sheet discharge port 7, a discharge roller pair 8, a discharge tray 9, and a postprocessing control unit (control unit) 10.

The sheet carry-in port 2 is provided, as it is opened, in a side face of the sheet postprocessing device 1 facing the sheet drying device 230. A sheet S conveyed from the sheet drying device 230 toward the sheet postprocessing device 1 passes through the sheet carry-in port 2 so as to be carried inward of the sheet postprocessing device 1.

The sheet conveyance unit 3 extends from the sheet carry-in port 2 to above the stacking tray 5 horizontally and more and more separately from the sheet drying device 230 (in a leftward direction in FIG. 2). The sheet carry-in port 2 is located at an upstream end of the sheet conveyance unit 3 in the sheet conveyance direction Dc. The sheet conveyance unit 3 conveys the sheet S, which has passed through the sheet carry-in port 2 so as to be carried inward of the sheet postprocessing device 1, from above the stacking tray 5 onto the stacking tray 5. Operation related to sheet conveyance in the sheet conveyance unit 3 is controlled by the postprocessing control unit 10.

The intermediate roller pair 4 is placed on the downstream side, in the sheet conveyance direction Dc, of a later-described punching portion 61 in the sheet conveyance unit 3. The intermediate roller pair 4 is placed on the upstream side of the sheet discharge port 7 in the sheet conveyance direction Dc. The intermediate roller pair 4 is located above an upstream portion of the stacking tray 5 in the sheet conveyance direction Dc. Rotational axes of the intermediate roller pair 4 extend along the sheet widthwise direction (drawing-sheet depthwise direction of FIGS. 2 and 4). The intermediate roller pair 4 feeds out the sheet S, which has been conveyed through the sheet conveyance unit 3, further toward the sheet discharge port 7 provided on the downstream side in the sheet conveyance direction Dc.

The stacking tray 5 is placed below a downstream portion of the sheet conveyance unit 3 in the sheet conveyance direction Dc. In more detail, the stacking tray 5 is located, as viewed in the sheet conveyance direction Dc, downstream of the intermediate roller pair 4 and immediately under the upstream side of the discharge roller pair 8. A sheet laying surface 5a of the stacking tray 5 is sloped so as to rise increasingly with increasing nearness to the downstream side in the sheet conveyance direction Dc. On the stacking tray 5, sheets S conveyed through the sheet conveyance unit 3 are stacked and subjected to specified processing. In other words, sheets S to be postprocessed are stacked on the stacking tray 5. The stacking tray 5 includes a pair of cursors 51 and alignment plates 52.

The pair of cursors 51 are placed on the sheet laying surface 5a of the stacking tray 5. The pair of cursors 51 are placed on one end side and the other end side, respectively, of the sheet conveyance unit 3 in the sheet widthwise direction relative to sheet-widthwise central part of the sheet conveyance unit 3, the pair of cursors 51 being opposed to each other in the sheet widthwise direction. The pair of cursors 51 are connected to cursor drivers 5D (see FIG. 3), respectively, each including a motor or the like that allows driving force to be imparted to the pair of cursors 51, so that the pair of cursors 51 are reciprocatively movable so as to go closer to or farther from each other along the sheet widthwise direction. The pair of cursors 51 make contact with one-side end edge and the other-side end edge, respectively, in the sheet widthwise direction, of a sheet S stacked on the stacking tray 5, by which the sheet S is aligned in the sheet widthwise direction. Operation of the pair of cursors 51 is controlled by the postprocessing control unit 10.

The alignment plates 52 are placed at upstream-side end portions of the stacking tray 5 in the sheet conveyance direction Dc. The alignment plates 52 are provided at plural points separated from one another in the sheet widthwise direction. Each alignment plate 52 is formed into a generally U-shape opened on the downstream side (upper left side in FIG. 4) of the sheet conveyance direction Dc, as viewed in the sheet widthwise direction (drawing-sheet depthwise direction in FIG. 4). An inner surface facing the downstream side in each alignment plate 52 having the generally U-shape is opposed to the upstream-side end edge of the sheet S stacked on the stacking tray 5, as viewed in the sheet conveyance direction Dc. The alignment plates 52 make contact with upstream-side end edges, in the sheet conveyance direction Dc, of sheets S stacked on the stacking tray 5 to fulfill alignment of the sheets S in the sheet conveyance direction Dc.

The postprocessing unit 6 executes specified postprocessing with a sheet S conveyed through the sheet conveyance unit 3 or sheets stacked on the stacking tray 5. The postprocessing unit 6 includes a punching portion 61 and a stapling portion 62. A sequence of operations related to the postprocessing in the postprocessing unit 6 are controlled by the postprocessing control unit 10.

The punching portion 61 is placed at a place between the sheet carry-in port 2 and the downstream end of the sheet conveyance unit 3. The sheet postprocessing device 1 is enabled to form a punched hole in sheets S, which are conveyed through the sheet conveyance unit 3, by subjecting the sheets S to punching process by the punching portion 61.

The stapling portion 62 is placed on the upstream side of the stacking tray 5 in the sheet conveyance direction Dc. The sheet postprocessing device 1 subjects a bundle of sheets S stacked on the stacking tray 5 to stapling process (stitching process) by using the stapling portion 62 to fulfill stitching of the sheet bundle.

The sheet discharge port 7 is placed on the downstream side of the intermediate roller pair 4 in the sheet conveyance direction Dc and, moreover, on the downstream side of the stacking tray 5 in the sheet conveyance direction Dc. A discharge roller pair 8 is placed at the sheet discharge port 7. A sheet S completely subjected to specified postprocessing in the stacking tray 5, as well as a sheet S having passed through on the stacking tray 5 without being subjected to postprocessing in the stacking tray 5, pass through the sheet discharge port 7 so as to be discharged toward the discharge tray 9.

The discharge roller pair 8 is placed at the sheet discharge port 7. The discharge roller pair 8 discharges a sheet S laid on the stacking tray 5 in the sheet conveyance direction Dc, and further discharges the sheet S through the sheet discharge port 7 to the discharge tray 9. Rotational axes of the discharge roller pair 8 extend along the sheet widthwise direction. The discharge roller pair 8 include a lower discharge roller 81 and an upper discharge roller 82.

The lower discharge roller 81 and the upper discharge roller 82 are placed at the sheet discharge port 7. The lower discharge roller 81 and the upper discharge roller 82 are coupled to discharge drivers 8D (see FIG. 3), respectively, so as to be rotatable independently of each other. The lower discharge roller 81 and the upper discharge roller 82 are enabled to make both forward rotation for discharging a sheet S to the discharge tray 9 side and reverse rotation for pulling in a sheet S to the stacking tray 5 side. Operations of the lower discharge roller 81 and the upper discharge roller 82 are controlled by the postprocessing control unit 10.

The upper discharge roller 82 is supported by an arm portion 11. The arm portion 11 extends along the sheet conveyance direction Dc and, at one end portion on the downstream end side in the sheet conveyance direction Dc, rotatably supports the upper discharge roller 82.

The arm portion 11 is supported, at one end portion on the upstream-end side of the sheet conveyance direction Dc, by the sheet postprocessing device 1 so as to be rotatable about an axis line of a rotational axis 11x extending along the sheet widthwise direction. The arm portion 11 is coupled to an arm driver 11D (see FIG. 3) so as to be swingable in an up/down direction with one end portion assigned as a free end, the one end portion supporting the upper discharge roller 82 about the axis line of the rotational axis 11x. Operation of the arm portion 11 is controlled by the postprocessing control unit 10.

Swinging of the arm portion 11 causes the upper discharge roller 82 to be moved in the up/down direction and so brought into contact with or separation from the lower discharge roller 81. The upper discharge roller 82 and the lower discharge roller 81, as shown in FIG. 4, have their circumferential surfaces brought into contact with each other to form a nip portion 8N. The upper discharge roller 82 and the lower discharge roller 81 convey a sheet S held by the nip portion 8N.

The sheet S discharged through the sheet discharge port 7 by forward rotation of the discharge roller pair 8 is stacked onto the discharge tray 9. Also, in an aspect in which the sheet S is held by the nip portion 8N of the discharge roller pair 8 while an upstream end of the sheet S in its discharge direction is apart from a nip portion 4N of the intermediate roller pair 4, exerting reverse rotation of the discharge roller pair 8 allows the sheet S to be conveyed to the stacking tray 5. That is, for conveyance of a sheet S to the stacking tray 5, the postprocessing control unit 10 executes a sheet pull-in operation by which the sheet S is switched back subsequent to passage of the downstream end portion of the sheet S in the sheet conveyance direction Dc through the sheet discharge port 7 so that the sheet S is pulled in to the upstream side on the stacking tray 5 in the sheet conveyance direction Dc. In FIGS. 4, 7 and 8, an arrow Dp is depicted which shows the pull-in direction of the sheet S on the stacking tray 5 toward the upstream side in the sheet conveyance direction Dc.

The discharge tray 9 is placed under the downstream side of the sheet discharge port 7 in the sheet conveyance direction Dc. In other words, the discharge tray 9 is placed on the downstream side of the stacking tray 5 in the sheet conveyance direction Dc. A sheet laying surface 9a of the discharge tray 9 is so sloped as to rise increasingly with increasing nearness to the downstream side of the sheet conveyance direction Dc. An upstream end of the discharge tray 9 in the sheet conveyance direction Dc is located under the sheet discharge port 7. The discharge tray 9 is placed outside a side face 1a of the sheet postprocessing device 1 in opposition to the side face 1a. The side face 1a, being a sheet reception wall for the sheet S discharged onto the discharge tray 9, extends in both a generally vertical direction and the sheet widthwise direction.

The discharge tray 9 can be moved generally vertically in the up/down direction by a tray driver 9D (see FIG. 3). On the discharge tray 9, sheets S discharged through the sheet discharge port 7 by the discharge roller pair 8 are stacked. The discharge tray 9 is one of final discharge places for sheets S in the sheet postprocessing device 1. Movement of the discharge tray 9 in the up/down direction is controlled by the postprocessing control unit 10.

The postprocessing control unit (control unit) 10 includes a CPU, an image processing unit, a storage unit, and other electronic circuits and electronic components (none shown). The postprocessing control unit 10 is communicatably connected to the recording control unit 223 of the inkjet recording device 220. The postprocessing control unit 10, receiving instructions from the recording control unit 223, controls operations of individual component elements provided in the sheet postprocessing device 1 on a basis of programs and data for control use stored in the storage unit by using the CPU, by which processes related to functions of the sheet postprocessing device 1 are fulfilled. The sheet conveyance unit 3, the intermediate roller pair 4, the stacking tray 5, the postprocessing unit 6, the discharge roller pair 8, and the discharge tray 9, individually receiving instructions from the postprocessing control unit 10, perform specified postprocessing processes, respectively, on the sheet S in linkage with one another. In addition, the functions of the postprocessing control unit 10 may instead be assigned to the recording control unit 223 of the inkjet recording device 220.

Further, as shown in FIGS. 3 and 4, the sheet postprocessing device 1 includes an air blower 12.

The air blower 12 includes an air blow fan 121 and a blowoff hole 122. The blowoff hole 122 is an opening through which an air flow Fa caused by driving of the air blow fan 121 is blown off. The blowoff hole 122 is placed above the upstream end of the stacking tray 5 in the sheet conveyance direction Dc. The air blow fan 121, although not shown in FIG. 4, is placed upstream of the blowoff hole 122 in the sheet conveyance direction Dc.

Then, the air blower 12 blows off, toward the downstream side of the sheet conveyance direction Dc, an air flow Fa to between a lower surface of a sheet S conveyed from the sheet conveyance unit 3 to the stacking tray 5 and the sheet laying surface 5a of the stacking tray 5 or an upper surface of a sheet S stacked on the stacking tray 5. In addition, depicted in FIG. 4 is a hollow arrow indicating a flow path and a flow direction of the air flow Fa of the air blower 12. Operation of the air blower 12 is controlled by the postprocessing control unit 10.

With the above-described configuration, when a succeeding sheet S is conveyed onto a plurality of sheets S already stacked on the stacking tray 5, an air flow impinges, from below, on the succeeding sheet S conveyed to the stacking tray 5. As a result, the succeeding sheet S can be deformed so as to be upwardly levitated at a vicinity of a downstream-side end portion of the succeeding sheet S in the sheet conveyance direction Dc. Thus, with regard to a succeeding sheet S that has been conveyed up to the stacking tray 5, it becomes possible to suppress unintentional contact of the succeeding sheet S with already stacked sheets S as well as occurrence of jamming of the succeeding sheet S. In consequence, it becomes implementable to improve the alignability of the sheets S on the stacking tray 5.

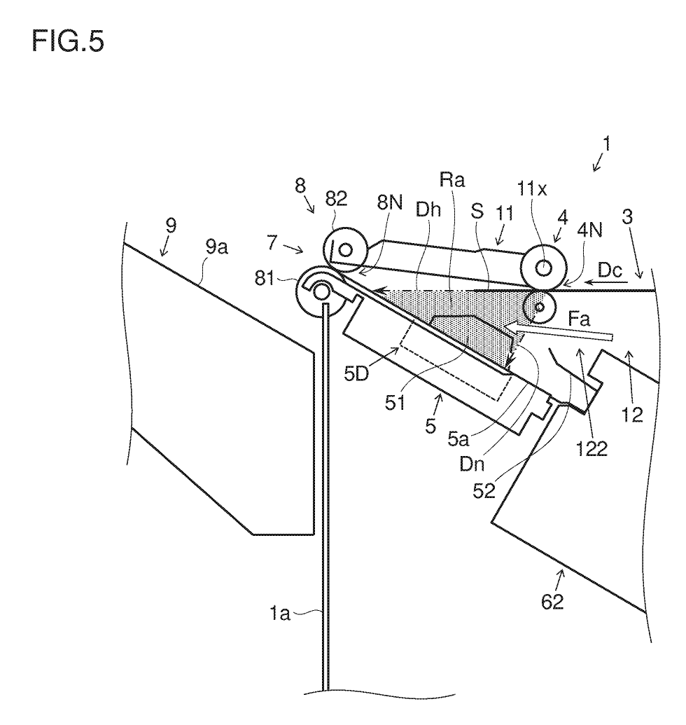

FIG. 5 is a partly cross-sectional front view showing a vicinity of the stacking tray 5 in the sheet postprocessing device 1 of FIG. 2, also being an explanatory view showing an air flow direction attributed to the air blower 12. As shown in FIG. 5, the air flow direction of the air flow Fa by the air blower 12 is so set as to fall within a hatched region Ra in the figure.

More specifically, the air flow direction of the air flow Fa by the air blower 12 is so set as to fall within an angular range between a direction Dh extending horizontally from the intermediate roller pair 4 toward the downstream side of the sheet conveyance direction Dc and a direction Dn extending from the intermediate roller pair 4 along a normal to the sheet laying surface 5a of the stacking tray 5. By properly setting the air flow direction of the air blower 12 to within a range between a direction of the sheet S fed out by the intermediate roller pair 4 and the sheet laying surface 5a of the stacking tray 5 as described above, it becomes possible to effectively suppress unintentional contact of a sheet S conveyed up to the stacking tray 5 with already stacked sheets S as well as occurrence of jamming of the sheet S. In consequence, it becomes possible to even further improve the alignability of the sheets S on the stacking tray 5.

In addition, since the blowoff hole 122 for the air flow Fa in the air blower 12 is placed above the upstream end of the stacking tray 5 in the sheet conveyance direction Dc, it becomes possible to blow the air flow Fa efficiently to between the lower surface of a sheet S conveyed up to the stacking tray 5 and the upper surface of a sheet S already stacked on the stacking tray 5. As a result, the effect of improving the alignability of sheets S on the stacking tray 5 can be enhanced to more extent.

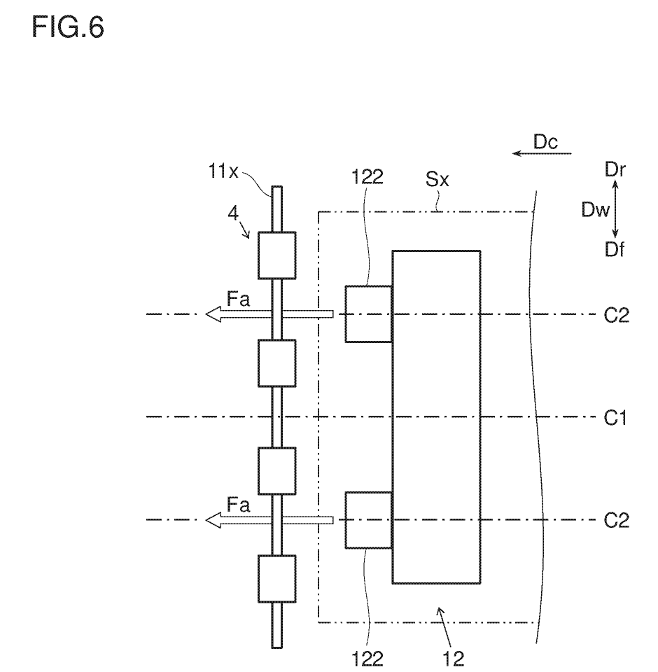

FIG. 6 is a plan view showing a vicinity of the air blower 12 of FIG. 4. It is noted that an up/down direction in FIG. 4 is equivalent to a sheet widthwise direction Dw (front/rear direction of the sheet postprocessing device 1) perpendicular to the sheet conveyance direction Dc of sheets S, and that lower part of FIG. 4 corresponds to the front side Df of the sheet postprocessing device 1 while upper part of FIG. 4 corresponds to the rear side Dr of the sheet postprocessing device 1.

The blowoff hole 122 for the air flow Fa in the air blower 12 may be placed in plurality along the sheet widthwise direction Dw in the stacking tray 5. In this embodiment, the blowoff hole 122 is placed, two in number, along the sheet widthwise direction Dw in the stacking tray 5. The blowoff holes 122 are placed on the front side Df and the rear side Dr, respectively one by one, of the sheet postprocessing device 1, relative to a central portion C1 of the stacking tray 5 in the sheet widthwise direction Dw. For example, two blowoff holes 122 are placed at central portions C2, respectively, of the sheet widthwise direction Dw in each of front- and rear-side half regions of the sheet widthwise direction Dw relative to the central portion C1 of the sheet widthwise direction Dw in a sheet Sx of the maximum size conveyed to the stacking tray 5.

By virtue of placing a plurality of blowoff holes 122 along the sheet widthwise direction in the stacking tray 5, it becomes possible to apply the air flow Fa to the sheet S over the entire range of the sheet S in the sheet widthwise direction Dw. Accordingly, for sheets S of various sizes, it becomes possible to improve the alignability of sheets S on the stacking tray 5.

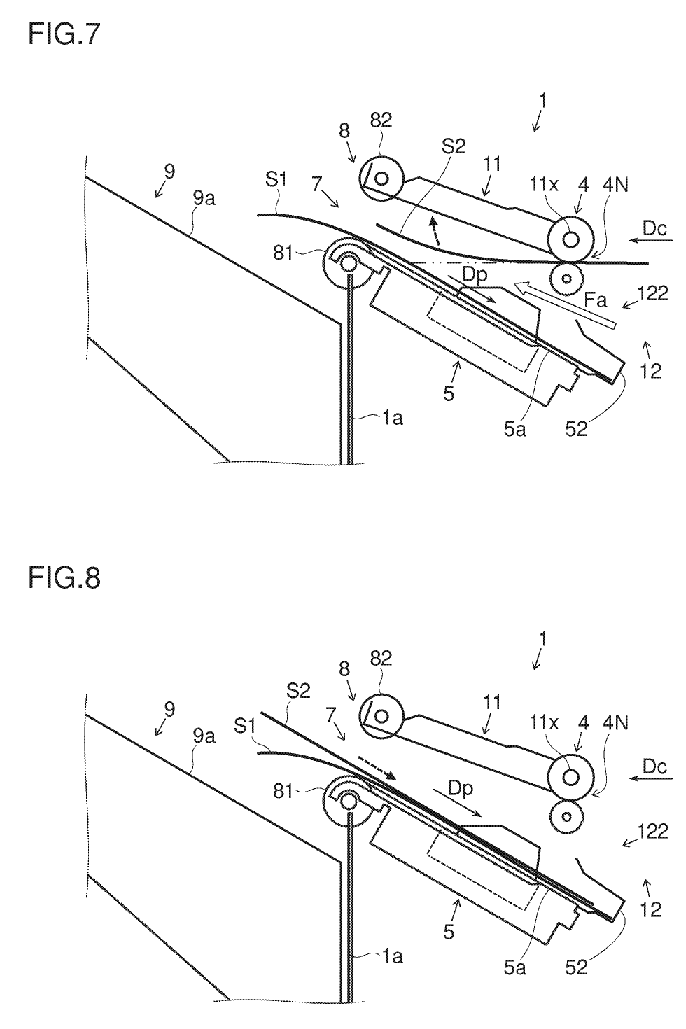

Next, detailed operations of the sheet postprocessing device 1 will be described. FIGS. 7 and 8 are partly cross-sectional front views each showing a vicinity of the stacking tray 5 of FIG. 4, where FIG. 7 shows a state in which a succeeding sheet S2 has been conveyed to above the stacking tray 5 having a preceding sheet S1 already stacked thereon, and FIG. 8 shows a state in which the succeeding sheet S2 has been stacked on the preceding sheet S1 already stacked on the stacking tray 5. For stacking of sheets S on the stacking tray 5, the postprocessing control unit 10 measures timings of rotations and halts of individual rollers as well as timings of swings and halts of the arm portion 11 in terms of rotational quantity, swinging quantity, and time.

As shown in FIG. 7, when a succeeding sheet S2 has been conveyed up to above the stacking tray 5 having a sheet S1 already stacked thereon, the postprocessing control unit 10 drives the air blower 12 to blow an air flow Fa to between the lower surface of the succeeding sheet S2 conveyed to the stacking tray 5 and the upper surface of the sheet S1 already stacked on the stacking tray 5. As a result, the succeeding sheet S2 conveyed to the stacking tray 5 is deformed so as to be upwardly levitated at a vicinity of a downstream-side end portion of the succeeding sheet S2 in the sheet conveyance direction Dc. In consequence, the sheet S2 conveyed to the stacking tray 5 can be prevented from unintentional contact with an already stacked sheet S1 and from occurrence of jamming.

Then, as shown in FIG. 8, the succeeding sheet S2 is stacked on the sheet S1 already stacked on the stacking tray 5, followed by a sheet pull-in operation in which the postprocessing control unit 10 pulls in the sheet S2 toward the upstream side on the stacking tray 5 in the sheet conveyance direction Dc. During execution of the sheet pull-in operation, the postprocessing control unit 10 halts air blow of the air blower 12. With this configuration, air blow that inhibits movement of the sheet S2 can be suppressed for the sheet S2 that is moving on the stacking tray 5 toward the upstream side of the sheet conveyance direction Dc. As a result, it becomes possible to improve alignability of sheets S on the stacking tray 5 by properly stacking a succeeding sheet S2 on a sheet S1 already stacked on the stacking tray 5.

Also, for example, in a case where a small-size (e.g., B5 size) sheet S is stacked on the stacking tray 5, applying air blow with air blow quantity equal to that for stacking of large-size (e.g., A3 size) sheets S onto the stacking tray 5 could cause the sheet S to be swept by wind and blocked from being properly stacked on the stacking tray 5. This is applicable also to sheets S which are given equally as sheets of fine quality paper but which are diverse in thickness so as to involve a resultant discrepancy between thinner (e.g., with a grammage of 40 g/m² or less) sheets S and thicker (e.g., with a grammage of 100 g/m² or more) sheets S.

Further, the air blower 12 includes, for example, a movable louver placed near the blowoff holes 122, and a drive source for driving the movable louver (neither shown). The air blower 12 is enabled to drive the movable louver by a motor or other drive source to change over the air flow direction to the sheet conveyance direction Dc or the sheet widthwise direction, whichever it is arbitrarily selectable.

Then, the postprocessing control unit 10 controls at least one of air-blow on/off status, air blow quantity, and air flow direction for the air blower 12 in response to size or grammage of sheets S. In addition, information as to which size and which grammage the sheet S to be stacked on the stacking tray 5 has is recognized by the postprocessing control unit 10 on a basis of information as to instructions related to postprocessing which are accepted from the recording control unit 223.

With the above-described configuration, an air flow Fa of proper air blow quantity and air flow direction is allowed to impinge, or blocked from impinging, on the lower surface of a sheet S conveyed to the stacking tray 5 in response to the size or grammage of the sheet S. As a result, the sheet S can be prevented from getting to a wind-sweep inducible state. Accordingly, it becomes implementable to improve the alignability of the sheet S on the stacking tray 5.

Also, the sheet S is a paper sheet on which an ink image is recorded by the inkjet recording device 220. That is, the sheet S is a paper sheet on which an image is recorded by an inkjet method. Sheets having aqueous ink deposited thereon increase in sheet-to-sheet friction due to water content. Therefore, blowing an air flow to between one sheet S and another sheet S under the above-described configuration makes it possible to reduce the sheet-to-sheet friction. As a result, sheets S each having an image recorded thereon by the inkjet method can be stacked in an orderly fashion on the stacking tray 5. That is, it becomes implementable to improve the alignability of sheets S on the stacking tray 5.

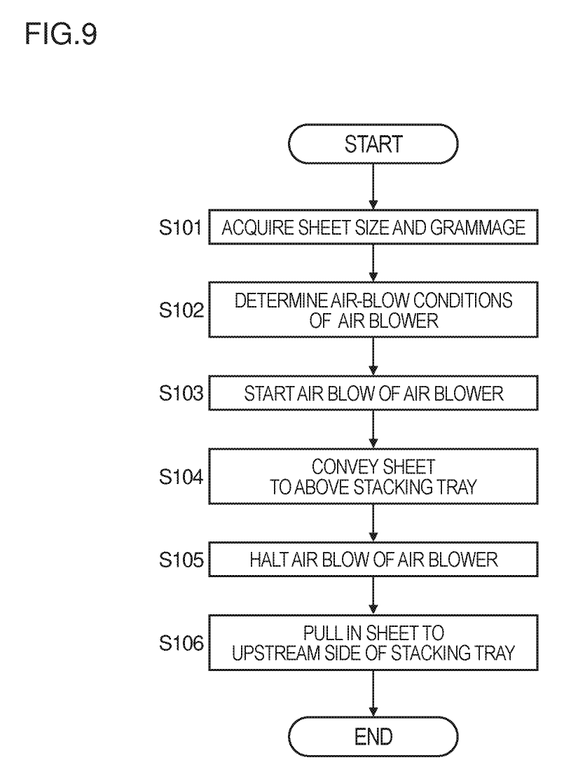

Next, a flow of sheet conveyance to the stacking tray 5 in the sheet postprocessing device 1 will be described. FIG. 9 is a flowchart showing an example of sheet conveyance process bound for the stacking tray 5 in the sheet postprocessing device 1 of FIG. 2.

When the sheet postprocessing device 1 in a powered-on state has accepted an instruction for a postprocessing job ('START' in FIG. 9), the postprocessing control unit 10, at step S101, acquires sheet information including size, grammage and the like of a sheet S next conveyed toward the stacking tray 5, followed by transition to step S102.

At step S102, the postprocessing control unit 10 determines air blow conditions including on/off status, air blow quantity, and the like of air blow by the air blower 12 in response to size or grammage of the sheet S, followed by transition to step S103. In addition, although not shown in detail, under a condition that the air blow of the air blower 12 is in off-status, the processing moves on to step S104.

At step S103, the postprocessing control unit 10 starts air blow of the air blower 12, followed by transition to step S104. In addition, the postprocessing control unit 10 drives the air blower 12 to give an air flow Fa to between the lower surface of a sheet S conveyed to the stacking tray 5 and the upper surface of another sheet S already stacked on the stacking tray 5.

At step S104, the postprocessing control unit 10 conveys the sheet S to above the stacking tray 5, and stacks the sheet S on the stacking tray 5, followed by transition to step S105. In addition, the sheet S conveyed through the sheet conveyance unit 3 goes apart from the nip portion 4N of the intermediate roller pair 4 so as to be conveyed to the stacking tray 5.

At step S105, the postprocessing control unit 10 halts air blow of the air blower 12, followed by transition to step S106.

At step S106, the postprocessing control unit 10 executes a sheet pull-in operation by which the sheet S is pulled in toward the upstream side on the stacking tray 5 in the sheet conveyance direction Dc. Then, the postprocessing control unit 10 ends the sheet conveyance process bound for the stacking tray 5 ('END' in FIG. 9).

In addition, when a plurality of stacked sheets S are to be stacked onto the stacking tray 5 in the postprocessing job, the processes from step S101 to step S106 are repeatedly executed.

Although the embodiment of the disclosure has been described hereinabove, the scope of the disclosure is not limited to this.

For instance, in the above embodiment, the image forming apparatus for forming (recording) images on sheets S to be subjected to postprocessing is assumed as the inkjet recording device 220. However, the image forming apparatus is not limited to such a configuration. The image forming apparatus may be an apparatus for forming a toner image with use of toner, followed by transfer and fixation of the toner image onto a sheet.

What is claimed is:

1. A sheet postprocessing device comprising:
a stacking tray for stacking thereon a sheet to be subjected to postprocessing;
a conveyance unit for conveying the sheet from above the stacking tray onto the stacking tray;
a postprocessing unit for subjecting the sheet, which has been stacked on the stacking tray, to the postprocessing;
a discharge tray which is placed on a downstream side of the stacking tray in a sheet conveyance direction and onto which the sheet is discharged; and
an air blower for blowing an air flow, toward a downstream side in the sheet conveyance direction, to between a lower surface of the sheet conveyed from the conveyance unit to the stacking tray and a sheet laying surface of the stacking tray or an upper surface of the sheet stacked on the stacking tray.

2. The sheet postprocessing device according to claim 1, wherein
the conveyance unit includes an intermediate roller pair for conveying the sheet from above the stacking tray onto the stacking tray; and
an air flow direction attributed to the air blower is set so as to fall within an angular range between one direction extending horizontally from the intermediate roller pair toward a downstream side of the sheet conveyance direction and another direction extending from the intermediate roller pair along a direction of a normal to the sheet laying surface of the stacking tray.

3. The sheet postprocessing device according to claim 1, wherein
a blowoff hole for the air flow in the air blower is placed above an upstream end of the stacking tray in the sheet conveyance direction.

4. The sheet postprocessing device according to claim 1, wherein
the blowoff hole for the air flow in the air blower is placed in plurality along a sheet widthwise direction of the stacking tray perpendicular to the sheet conveyance direction.

5. The sheet postprocessing device according to claim 1, further comprising
a control unit for controlling operations of the conveyance unit, the postprocessing unit, and the air blower, wherein
the control unit halts air blow of the air blower during execution of a sheet pull-in operation by which the sheet conveyed by the conveyance unit is pulled in toward an upstream side on the stacking tray in the sheet conveyance direction.

6. The sheet postprocessing device according to claim 1, further comprising
a control unit for controlling operations of the conveyance unit, the postprocessing unit, and the air blower, wherein
the control unit controls at least one of air-blow on/off status, air blow quantity, and air flow direction for the air blower in response to size or grammage of the sheet.

7. The sheet postprocessing device according to claim 1, wherein
the sheet is a paper sheet on which an image is recorded by an inkjet method.

8. An image forming system comprising:
an image forming apparatus for forming an image on a sheet; and
the sheet postprocessing device according to claim 1 for applying the postprocessing to the sheet that has been subjected to image formation in the image forming apparatus.
